(19) United States
(12) Patent Application Publication
(10) Pub. No.: US 2025/0200750 A1
(43) Pub. Date: Jun. 19, 2025

(54) MEDICAL IMAGE PROCESSING APPARATUS, MEDICAL IMAGE PROCESSING METHOD, AND COMPUTER-READABLE NONVOLATILE STORAGE MEDIUM THAT STORES MEDICAL IMAGE PROCESSING PROGRAM

(71) Applicant: CANON MEDICAL SYSTEMS CORPORATION, Otawara-shi (JP)

(72) Inventors: Shuhei BANNAE, Utsunomiya (JP); Hiroshizu MORISHIMA, Utsunomiya (JP)

(73) Assignee: CANON MEDICAL SYSTEMS CORPORATION, Otawara-shi (JP)

(21) Appl. No.: 18/984,559

(22) Filed: Dec. 17, 2024

(30) Foreign Application Priority Data
Dec. 18, 2023 (JP) 2023-212727
Dec. 17, 2024 (JP) 2024-220529

(51) Int. Cl. G06T 7/00

(52) U.S. Cl. CPC G06T 7/0016; G06T 2200/24; G06T 2207/10092; G06T 2207/10121; G06T 2207/30101

(57) ABSTRACT

A medical image processing apparatus according to an embodiment includes processing circuitry and a display. The processing circuitry acquires a 1st medical image collected by predetermined imaging for an imaging part of a subject, and a 2nd medical image that is collected by imaging different from the predetermined imaging and includes a blood vessel related to the imaging part, detects a disease candidate region indicating a candidate for a region of a disease at the imaging part based on the 1st medical image, detects a constriction part related to constriction of the blood vessel based on the 2nd medical image, and estimates certainty of the disease for the disease candidate region based on the disease candidate region and the constriction part. The display displays the region of the disease related to the certainty and the 2nd medical image that are superimposed on the 1st medical image.

### CROSS-REFERENCE TO RELATED APPLICATIONS

This application is based upon and claims the benefit of priority from Japanese Patent Application No. 2023-212727, filed on Dec. 18, 2023; and Japanese Patent Application No. 2024-220529, filed on Dec. 17, 2024; the entire contents of which are incorporated herein by reference.

### FIELD

Embodiments described herein relate generally to a medical image processing apparatus, a medical image processing method, and a computer-readable nonvolatile storage medium that stores a medical image processing program.

### BACKGROUND

In the related art, as a method for automatically detecting a location of a cerebral infarction in an acute phase, there is known a method using a non-contrast computed tomography (CT) image or a diffusion weighted image (DWI). However, in the non-contrast CT image, variation in a signal value is smaller in an infarction region than in a normal region. Due to this, it may be difficult to detect a location of a cerebral infarction in an acute phase in the non-contrast CT image. On the other hand, variation in a signal value is large in the infarction region in the DWI, but the DWI may be easily affected by image quality or an artifact.

### BRIEF DESCRIPTION OF THE DRAWINGS

FIG. 1 is a block diagram illustrating an example of a configuration of a medical image processing system including a medical image processing apparatus according to an embodiment;

FIG. 2 is a diagram illustrating an example of a disease candidate region according to the embodiment detected in an ADC map;

FIG. 3 is a diagram illustrating an example of disease candidate regions DCR according to the embodiment detected in a non-contrast CT image;

FIG. 4 is a flowchart illustrating an example of a procedure of region estimation display processing according to the embodiment;

FIG. 5 is a diagram illustrating an example of a second medical image superimposed on a first medical image, a disease region, and a constriction part according to the embodiment;

FIG. 6 is a diagram illustrating an example of the second medical image superimposed on the first medical image, three disease regions in a display mode corresponding to a binary value of certainty, and the constriction part according to the embodiment;

FIG. 7 is a diagram illustrating an example of the second medical image superimposed on the first medical image, three disease regions in a display mode corresponding to a degree of certainty, and the constriction part according to the embodiment; and

FIG. 8 is a diagram illustrating an example of a comparative example.

### DETAILED DESCRIPTION

A medical image processing apparatus according to an embodiment includes processing circuitry and a display. The processing circuitry acquires a first medical image collected by predetermined imaging for an imaging part of a subject, and a second medical image that is collected by imaging different from the predetermined imaging and includes a blood vessel related to the imaging part. The processing circuitry detects a disease candidate region indicating a candidate for a region of a disease at the imaging part based on the first medical image. The processing circuitry detects a constriction part related to constriction of the blood vessel based on the second medical image. The processing circuitry estimates certainty of the disease for the disease candidate region based on the disease candidate region and the constriction part. The display displays the region of the disease related to the certainty and the second medical image that are superimposed on the first medical image.

The following describes the embodiment of the medical image processing apparatus, a medical image processing method, and a medical image processing program with reference to the drawings. In the following embodiment, redundant description will be appropriately omitted assuming that portions denoted by the same reference numeral perform the same operation.

### Embodiment

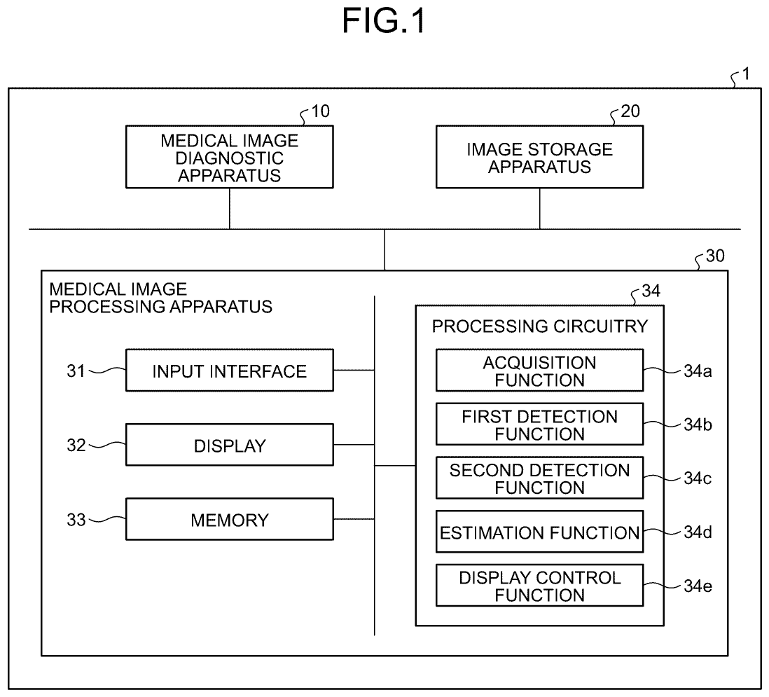

FIG. 1 is a block diagram illustrating an example of a configuration of a medical image processing system 1 including a medical image processing apparatus 30 according to the embodiment. As illustrated in FIG. 1, the medical image processing system 1 according to the embodiment includes a medical image diagnostic apparatus 10, an image storage apparatus 20, and the medical image processing apparatus 30. As illustrated in FIG. 1, the medical image diagnostic apparatus 10, the image storage apparatus 20, and the medical image processing apparatus 30 are connected to each other via a network.

The medical image diagnostic apparatus 10 is connected to, for example, a magnetic resonance imaging (MRI) apparatus, an X-ray computed tomography (CT) apparatus, and/or an X-ray blood vessel photographing apparatus (also referred to as X-ray angiography). Each of the MRI apparatus, the X-ray CT apparatus, and the X-ray blood vessel photographing apparatus is an example of an image imaging apparatus. The medical image diagnostic apparatus 10 collects a first medical image and a second medical image by imaging a subject. For example, the medical image diagnostic apparatus 10 collects the first medical image by predetermined imaging for an imaging part of the subject. The medical image diagnostic apparatus 10 also collects the second medical image collected by imaging different from the predetermined imaging. The second medical image includes a blood vessel related to the imaging part. The second medical image may be the same cross section as the first medical image, or may be a cross section different from the first medical image. An imaging region related to the second medical image may be the same as an imaging region of the first medical image, or may be different from the imaging region of the first medical image. Each of the first medical image and the second medical image is assumed to be an axial cross section of the imaging part, or a coronal cross section of the imaging part. The imaging part is assumed to be a brain of the subject, for example. The first medical image and the second medical image are images obtained by imaging the subject at different timings, for example.

The MRI apparatus collects magnetic resonance images (MR images) from the subject. For example, the MRI apparatus generates an MR image by collecting, from the subject, and reconstructing MR data. The MRI apparatus transmits the generated MR image to the image storage apparatus 20 and the medical image processing apparatus 30. A known configuration can be applied to a configuration of the MRI apparatus, so that description thereof will not be provided. The MRI image is, for example, a diffusion weighted image (Diffusion Weighted Imaging: DWI), a magnetic resonance angiography image (hereinafter, referred to as an MR Angiography (MRA) image), or the like. The diffusion weighted image also includes an apparent diffusion coefficient (ADC) map.

In a case in which the first medical image and the second medical image are collected by the MRI apparatus, the DWI image corresponds to the first medical image, and the MRA image corresponds to the second medical image. In a case in which the first medical image and the second medical image are collected by the MRI apparatus, the predetermined imaging is diffusion weighted (DW) imaging (DW-EPI) using echo planar imaging (EPI), for example. A known imaging method based on a T2-weighted image can be applied to the DW imaging, so that description thereof will not be provided. Typically, the DW imaging is performed for an axial cross section of the imaging part or a coronal cross section of the imaging part. The different imaging is MRA imaging. The different imaging is MRA imaging for the same cross section as a cross section related to the DWI image or a cross section different therefrom. A known imaging method can be applied to the MRA imaging, so that description thereof will not be provided. The MRA image is a non-contrast image, and is often imaged by the same inspection as that for the DWI image, so that it is advantageous that it can be easily obtained.

The X-ray CT apparatus acquires an X-ray CT image (CT image) related to the subject by exposing the subject with X-rays. For example, the X-ray CT apparatus generates the CT image by collecting and reconstructing projection data related to the subject. The X-ray CT apparatus transmits the generated CT image to the image storage apparatus 20 or the medical image processing apparatus 30. A known configuration can be applied to a configuration of the X-ray CT apparatus, so that description thereof will not be provided. The X-ray CT image is, for example, a non-contrast X-ray CT image (hereinafter, referred to as a non-contrast CT image), a contrast X-ray CT image (hereinafter, referred to as a contrast CT image (CTA image)), or the like.

In a case in which the first medical image and the second medical image are collected by the X-ray CT apparatus, the non-contrast CT image corresponds to the first medical image, and the contrast CT image corresponds to the second medical image. In a case in which the first medical image and the second medical image are collected by the MRI apparatus, the predetermined imaging corresponds to, for example, scanning the imaging part in a non-contrast manner, and the different imaging corresponds to contrast scanning. For example, the different imaging corresponds to contrast scanning for the same cross section as a cross section related to the non-contrast image or a cross section different therefrom.

An X-ray angiographic apparatus acquires a blood vessel image (angiography image) related to the subject by exposing the subject with X-rays. For example, the X-ray angiographic apparatus generates an angiography image by X-ray photography while a contrast medium is given to the subject. The X-ray angiographic apparatus transmits the generated angiography image to the image storage apparatus 20 or the medical image processing apparatus 30. A known configuration can be applied to a configuration of the X-ray angiographic apparatus, so that description thereof will not be provided. In a case in which the second medical image is collected by the X-ray angiographic apparatus, the angiography image corresponds to the second medical image. The different imaging corresponds to contrast imaging. For example, the different imaging corresponds to contrast imaging including the same cross section as a cross section related to the first medical image or a cross section different therefrom.

The first medical image and the second medical image are not limited to the axial cross section of the imaging part, or the coronal cross section of the imaging part. The imaging may be volume scanning for a brain of the subject, or may be performed for another cross section such as an oblique cross section. At this point, the first medical image and the second medical image are generated by cross-section conversion processing for generated volume data.

The image storage apparatus 20 stores the first medical image, the second medical image, and the like collected by the medical image diagnostic apparatus 10. For example, the image storage apparatus 20 is implemented by computer equipment such as a server apparatus. Specifically, the image storage apparatus 20 is implemented by a picture archiving and communication system (PACS) server and the like. The image storage apparatus 20 may also be referred to as a medical image management system. In the present embodiment, the image storage apparatus 20 acquires the first medical image and the second medical image from the medical image diagnostic apparatus 10 via the network, and causes the acquired first medical image and second medical image to be stored in a memory that is disposed inside the apparatus or outside the apparatus.

The medical image processing apparatus 30 acquires the first medical image and the second medical image from the medical image diagnostic apparatus 10 or the image storage apparatus 20 via the network, and performs various kinds of processing using the acquired first medical image and second medical image. The medical image processing apparatus 30 may also be referred to as a medical image analysis apparatus or an analysis apparatus. For example, the medical image processing apparatus 30 is implemented by computer equipment such as a workstation. The medical image processing apparatus 30 causes a display 32 to display a result of processing that is processed based on the first medical image and the second medical image.

As illustrated in FIG. 1, the medical image processing apparatus 30 includes an input interface 31, the display 32, a memory 33, and processing circuitry 34.

The input interface 31 is implemented by a trackball, a switch, a button, a mouse, and a keyboard for making various instructions and various settings, a touch pad for performing input operation by touching an operation surface, a touch screen obtained by integrating a display screen and a touch pad, non-contact input circuitry using an optical sensor, voice input circuitry, or the like. The input interface 31 converts an input operation received from an operator into an electric signal to be output to the processing circuitry 34.

The input interface 31 does not necessarily include a physical operation component such as a mouse and a keyboard. For example, examples of the input interface 31 include electric signal processing circuitry that receives an electric signal corresponding to the input operation from external input equipment that is disposed separately from the medical image processing apparatus 30, and outputs the electric signal to the processing circuitry 34. The input interface 31 is an example of an input unit.

The display 32 displays various pieces of information under control by a display control function 34e. For example, the display 32 displays a graphical user interface (GUI) for receiving an instruction from the operator, and various kinds of X-ray image data. For example, the display 32 is a liquid crystal display or a Cathode Ray Tube (CRT) display. The display 32 is an example of a display unit.

For example, the memory 33 is implemented by a random access memory (RAM), a semiconductor memory element such as a flash memory, a hard disk, an optical disc, and the like. For example, the memory 33 stores the first medical image and the second medical image acquired from the medical image diagnostic apparatus 10 or the image storage apparatus 20. For example, the memory 33 also stores a computer program for each piece of circuitry included in the medical image processing apparatus 30 to implement a function thereof. The memory 33 is an example of a storage unit.

The processing circuitry 34 controls operation of the entire medical image processing apparatus 30 by executing an acquisition function 34a, a first detection function 34b, a second detection function 34c, an estimation function 34d, and the display control function 34e.

The processing circuitry 34 acquires the first medical image and the second medical image from the medical image diagnostic apparatus 10 or the image storage apparatus 20 by reading out, from the memory 33, and executing a computer program that implements the acquisition function 34a. The acquisition function 34a causes the memory 33 to store the first medical image and the second medical image. The processing circuitry 34 that implements the acquisition function 34a corresponds to an acquisition unit.

The processing circuitry 34 reads out, from the memory 33, and executes a computer program that implements the first detection function 34b. Due to this, the first detection function 34b detects a disease candidate region based on the first medical image. The disease candidate region indicates a candidate for a region of a disease at the imaging part of the first medical image. The first detection function 34b performs image processing on the first medical image, and specifies the disease candidate region in the first medical image.

For example, the first detection function 34b specifies, as the disease candidate region, a plurality of pixels each having a pixel value lower than a predetermined threshold in the first medical image. In a case in which the first medical image is the ADC map, for example, the predetermined threshold corresponds to a value having an apparent diffusion coefficient (ADC) lower than a healthy portion (hereinafter, referred to as an ADC threshold). The ADC threshold is set in advance and stored in the memory 33. A value having a small apparent diffusion coefficient corresponds to a tissue affected by an infarction of a blood vessel. Thus, in a case in which the imaging part is a brain, the disease candidate region corresponds to a region in which a cerebral infarction is caused.

The disease candidate region is not necessarily specified by segmentation processing using the ADC threshold for the ADC map in the first medical image. For example, a pre-learned model that outputs the disease candidate region using the first medical image as an input may be used for specifying a first region.

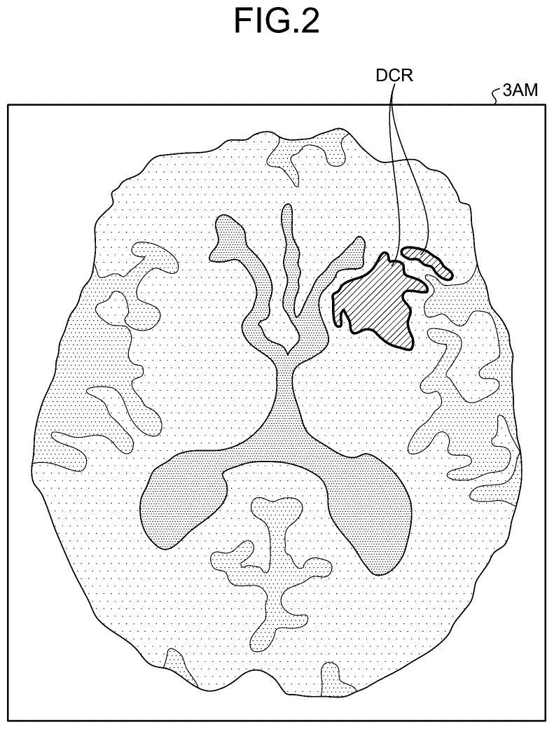

FIG. 2 is a diagram illustrating an example of a disease candidate region DCR detected in an ADC map 3 AM. The ADC map 3 AM in FIG. 2 indicates a case in which the imaging part is a brain. As illustrated in FIG. 2, for example, the first detection function 34b detects disease candidate regions DCR at two points by performing image processing on the ADC map 3 AM corresponding to the first medical image.

In a case in which the first medical image is a non-contrast CT image, the predetermined threshold corresponds to a CT value corresponding to a constriction region of a blood vessel. At this point, for example, the predetermined threshold corresponds to a CT value for discriminating an early CT sign in the non-contrast CT image. The predetermined threshold for discriminating the early CT sign is stored in the memory 33 set in advance.

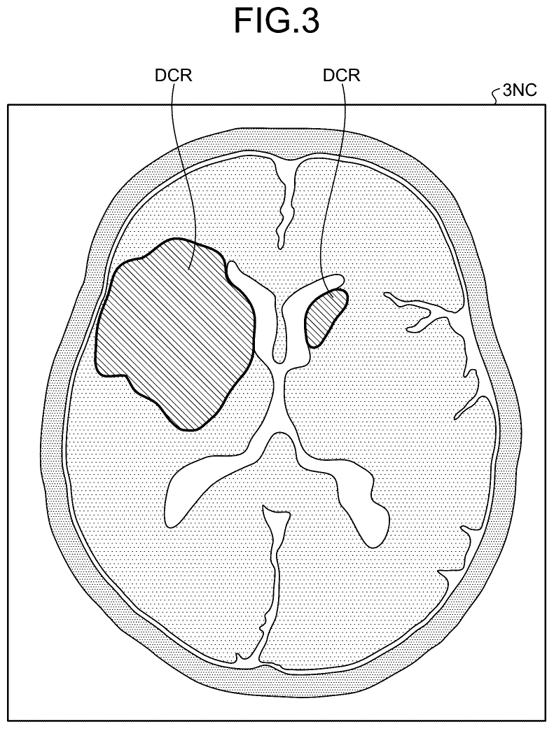

FIG. 3 is a diagram illustrating an example of the disease candidate regions DCR detected in a non-contrast CT image 3NC. The non-contrast CT image 3NC in FIG. 3 indicates a case in which the imaging part is a brain. As illustrated in FIG. 3, for example, the first detection function 34b detects the disease candidate regions DCR at two points by performing image processing on the non-contrast CT image 3NC corresponding to the first medical image.

The processing circuitry 34 causes the first detection function 34b to associate the detected disease candidate region with the first medical image to be stored in the memory 33. The number of disease candidate regions detected by the first detection function 34b is not limited to one, but may be multiple. The processing circuitry 34 that implements the first detection function 34b corresponds to a first detection unit.

The processing circuitry 34 reads out, from the memory 33, and executes a computer program that implements the second detection function 34c. Due to this, the second detection function 34c detects a constriction part based on the second medical image. The constriction part is a portion related to constriction of a blood vessel related to the imaging part, and includes an infarction part (infarction point) of the blood vessel. For example, the constriction part is a region in which blood vessels on a downstream side of a constriction position are distributed. Specifically, the constriction part corresponds to a region dominated by the downstream blood vessels (hereinafter, referred to as a vascular dominated region).

The vascular dominated region is, for example, a middle cerebral artery (MCA) region, an anterior cerebral artery (ACA) region, a deep penetrating artery (anterior choroidal artery) region of an internal carotid artery (ICA), a posterior cerebral artery (PCA) region, a posterior inferior cerebellar artery (PICA) region, an anterior inferior cerebellar artery (AICA) region, a superior cerebellar artery (SCA) region, and the like. The disease region is included in the constriction part.

The processing circuitry 34 detects a constriction part in the second medical image through various kinds of image processing on an MRA image, a contrast CT image, or an angiography image by the second detection function 34c. Known processing such as known segmentation processing, threshold processing, or use of a pre-learned model can be applied to the image processing, so that description thereof will not be provided.

The processing circuitry 34 may detect a degree of constriction of the blood vessel at the constriction position at the constriction part, for example, a constriction rate, based on the constriction part in the second medical image by the second detection function 34c. A known method such as using a ratio of an inner diameter of a blood vessel at a constriction position to an inner diameter of a blood vessel on an upstream side of the constriction part can be used for detecting the degree of constriction of the blood vessel at the constriction part, for example, for calculating the constriction rate, so that description thereof will not be provided.

The processing circuitry 34 causes the second detection function 34c to associate the detected constriction part with the second medical image to be stored in the memory 33. In a case in which the degree of constriction of the blood vessel at the constriction part has been detected, the second detection function 34c associates the detected degree of constriction with the constriction part to be stored in the memory 33. The number of constriction parts detected by the second detection function 34c is not limited to one, but may be multiple. The processing circuitry 34 that implements the second detection function 34c corresponds to a second detection unit. The first detection function 34b and the second detection function 34c may be integrated with each other as a detection function.

The processing circuitry 34 reads out, from the memory 33, and executes a computer program that implements the estimation function 34d. Due to this, the estimation function 34d estimates certainty of the disease for the disease candidate region based on the disease candidate region and the constriction part. In a case in which the constriction part overlaps the disease candidate region, the certainty is higher than that in a case in which the constriction part does not overlap the disease candidate region. For example, in a case in which the constriction part encompasses the disease candidate region, the estimation function 34d estimates the highest certainty because the constriction part matches the disease candidate region. For example, in a case in which the constriction part does not overlap the disease candidate region at all, the estimation function 34d estimates the lowest certainty.

The processing circuitry 34 may calculate a size (area) of an overlapping region in which the constriction part overlaps the disease candidate region by the estimation function 34d. At this point, the estimation function 34d reads out a predetermined value set in advance from the memory 33. Subsequently, the estimation function 34d compares the size of the overlapping region with the predetermined value. In a case in which the size of the overlapping region of the constriction part and the disease candidate region is smaller than the predetermined value, the estimation function 34d estimates that the disease candidate region is false positive as the certainty of the disease.

In a case in which the calculated size of the overlapping region is equal to or larger than the predetermined value, the estimation function 34d estimates that the disease candidate region is non-false positive (for example, true positive) as the certainty of the disease. The estimation function 34d that estimates whether the disease candidate region is false positive (a binary value corresponding to presence/absence of positiveness) may be mounted on the processing circuitry 34 as a determination function. At this point, the processing circuitry 34 that implements the determination function corresponds to a determination unit.

The processing circuitry 34 may estimate, by the estimation function 34d, a probability of the disease corresponding to the certainty based on the size of the overlapping region of the constriction part and the disease candidate region and the degree of constriction. For example, the estimation function 34d reads out a table of correspondence from the memory 33. The table of correspondence is a look up table (LUT) representing the probability of the disease with respect to the size of the overlapping region and the degree of constriction (for example, the constriction rate). The LUT is stored in the memory 33 set in advance. The estimation function 34d estimates the probability of the disease by comparing the size of the overlapping region with the degree of constriction with the LUT.

The probability of the disease is not necessarily estimated by using the LUT, but may be estimated by a pre-learned model or a computational expression that outputs the probability of the disease using the size of the overlapping region and the degree of constriction as inputs, for example. For example, a state of the blood vessel at the constriction part is not occlusion but constriction, the estimation function 34d lowers the probability of the detected disease candidate region as compared with that at the time of occlusion. In other words, if the state of the blood vessel at the constriction part is occlusion, the estimation function 34d raises the probability of the detected disease candidate region as compared with that at the time of constriction.

The estimation function 34d may estimate a region of the disease related to the estimated certainty of the disease (hereinafter, referred to as a disease region). That is, the estimation function 34d may estimate the certainty of the disease in the disease candidate region, and estimate the disease region corresponding to the estimated certainty of the disease. For example, the estimation function 34d specifies a disease region related to false positive and a disease region related to non-false positive (true positive) for each of the disease candidate regions.

The estimation function 34d may also specify the disease region corresponding to the probability of the disease for each of the disease candidate regions. In other words, the estimation function 34d may specify the disease region corresponding to the estimated certainty of the disease based on the disease candidate regions and the estimated certainty of the disease. The estimation function 34d that estimates the disease region may also be referred to as a specification function. At this point, the processing circuitry 34 that implements the specification function corresponds to a specification unit.

The processing circuitry 34 causes the estimation function 34d to associate the disease candidate region DCR with the estimated certainty of the disease, false positive or non-false positive, and/or the probability of the disease to be stored in the memory 33. The processing circuitry 34 that implements the estimation function 34d corresponds to an estimation unit.

The processing circuitry 34 reads out, from the memory 33, and executes a computer program corresponding to the display control function 34e. Due to this, the display control function 34e causes the display 32 to display the region of the disease related to the certainty and the second medical image that are superimposed on the first medical image. The region of the disease (disease region) related to the certainty is, for example, a disease candidate region having high certainty, a disease candidate region estimated to be non-false positive, a disease candidate region having a high probability of the disease, and the like.

Specifically, in a case in which the disease candidate regions are detected by the first detection function 34b, the disease region displayed on the display 32 is a disease candidate region having the highest certainty, a disease candidate region estimated to be non-false positive (true positive), a disease candidate region having the highest probability of the disease, and the like. The region of the disease related to the certainty may be a disease candidate region estimated to be false positive.

More specifically, the processing circuitry 34 causes the first medical image and the second medical image to positionally correspond to each other by alignment (registration) of the first medical image and the second medical image by the display control function 34e. The alignment of the first medical image and the second medical image is, for example, implemented by image processing using respective anatomical landmarks in the first medical image and the second medical image.

The alignment of the first medical image and the second medical image is not limited to alignment using the anatomical landmarks, but may be implemented by another method such as a method using various kinds of image recognition processing. The alignment of the first medical image and the second medical image may also be implemented by an image processing function and the like (not illustrated).

Subsequently, the processing circuitry 34 causes the display control function 34e to superimpose the second medical image after alignment on the first medical image. For example, in a case in which the first medical image is a DWI image and the second medical image is an MRA image, the display control function 34e superimposes the MRA image on the DWI image to be displayed on the display 32. At this point, the display control function 34e further superimposes the disease region on the superimposed image in which the MRA image is superimposed on the DWI image, and displays it on the display 32. Due to this, the display 32 displays the disease region related to the certainty and the second medical image that are superimposed on the first medical image.

The processing circuitry 34 may cause the display control function 34e to further superimpose the certainty corresponding to the disease region on the superimposed image to be displayed on the display 32. In a case in which a plurality of the disease candidate regions are detected and each of the disease candidate regions is estimated to be false positive or non-false positive, the display control function 34e causes the display 32 to display a boundary line (frame line) of the disease region corresponding to false positive and a boundary line of the disease region corresponding to non-false positive in different display modes. The boundary line of the disease region is a line indicating a boundary between the disease region and tissues adjacent to the disease region. The different display modes mean, for example, different hues or different line types.

For example, the display control function 34e causes the display 32 to display the boundary line of the disease region related to false positive and the boundary line of the disease region related to non-false positive to be further imposed on the superimposed image with different hues or different line types. Due to this, the display 32 displays the boundary line of the disease region corresponding to false positive and the boundary line of the disease region corresponding to non-false positive in different display modes.

The processing circuitry 34 causes the display 32 to display the disease region in a display mode corresponding to the probability by the display control function 34e. For example, the display control function 34e displays the boundary line of the disease region to be further superimposed on the superimposed image with a hue or a line type corresponding to magnitude of the probability. Due to this, the display 32 displays the disease region in a display mode corresponding to the probability.

The processing circuitry 34 may cause the memory 33 or the image storage apparatus 20 to store the image displayed on the display 32 by the display control function 34e. The processing circuitry 34 that implements the display control function 34e corresponds to a display control unit.

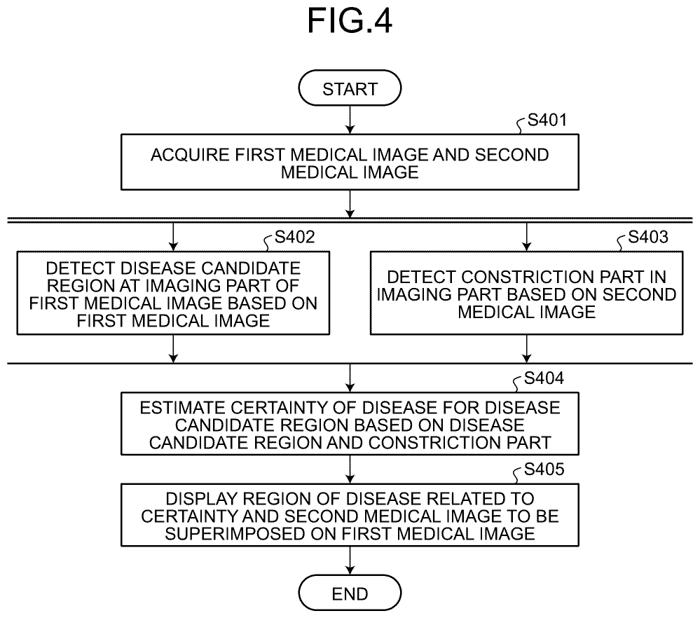

The entire configuration of the medical image processing system 1 according to the embodiment has been described above. The following describes processing of estimating and displaying the certainty of the disease region using the first medical image and the second medical image (hereinafter, referred to as region estimation display processing) with reference to FIG. 4.

FIG. 4 is a flowchart illustrating an example of a procedure of the region estimation display processing. For specific description, it is assumed that the imaging part is the brain of the subject as described above, the first medical image is the diffusion weighted image, and the second medical image is the MRA image. It is assumed that the first medical image and the second medical image are generated in advance by MR imaging for the subject before the region estimation display processing is performed.

### Region Estimation Display Processing

### Step S401

The processing circuitry 34 acquires, by the acquisition function 34a, the first medical image and the second medical image from the medical image diagnostic apparatus (MRI apparatus) 10 or the image storage apparatus 20. The acquisition function 34a causes the memory 33 to store the first medical image and the second medical image.

### Step S402

The processing circuitry 34 detects the disease candidate region at the imaging part of the first medical image based on the first medical image by the first detection function 34b. For specific description, it is assumed that a plurality of the disease candidate regions are detected in the following description. The first detection function 34b causes the memory 33 to store the detected disease candidate regions.

### Step S403

The processing circuitry 34 detects, by the second detection function 34c, a constriction part in the imaging part of the second medical image, that is, a vascular dominated region positioned on the downstream side of the constriction position, based on the second medical image. The second detection function 34c may detect a degree of constriction of the blood vessel at the constriction position in the constriction part based on the constriction part in the second medical image. The second detection function 34c associates the detected constriction part and the degree of constriction with the second medical image to be stored in the memory 33.

### Step S404

The processing circuitry 34 estimates, by the estimation function 34d, the certainty of the disease for the disease candidate region based on the disease candidate region and the constriction part. For example, the estimation function 34d estimates the certainty of the disease (false positive, non-false positive (true positive), the probability of the disease, and the like) in the disease candidate region for each of the disease candidate regions. Due to this, the estimation function 34d associates the disease candidate regions with the certainty of the disease and the first medical image to be stored in the memory 33 as a disease region.

### Step S405

The processing circuitry 34 causes the display control function 34e to superimpose the region of the disease (disease region) related to the certainty and the second medical image on the first medical image to be displayed on the display 32. That is, the display 32 displays a superimposed image in which the disease region and the second medical image are superimposed on the first medical image. At this point, the display control function 34e may further superimpose the constriction part on the superimposed image to be displayed on the display 32. At this point, the display control function 34e may further superimpose the constriction position (including an occlusion position) on the superimposed image to be displayed on the display 32.

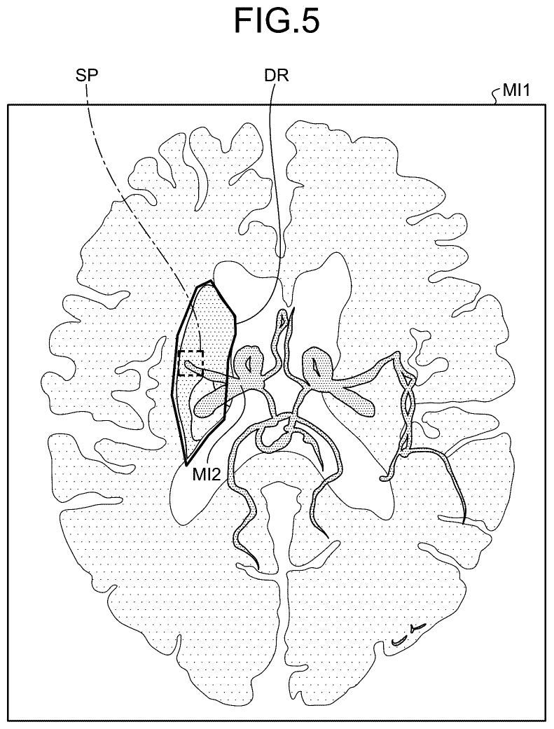

FIG. 5 is a diagram illustrating an example of a second medical image MI2 superimposed on a first medical image MI1, a disease region DR, and a constriction part SP. The first medical image MI1 in FIG. 5 corresponds to the DWI image. The second medical image MI2 in FIG. 5 corresponds to the MRA image. As illustrated in FIG. 5, the constriction part SP is included in the disease region DR in the first medical image MI1.

The processing circuitry 34 may change, by the display control function 34e, the display mode of the disease region DR in accordance with a binary value corresponding to the certainty (for example, whether the disease region is false positive), and cause the display 32 to display the superimposed image. At this point, the display 32 displays the disease region DR in the display mode corresponding to the binary value corresponding to the certainty in the superimposed image.

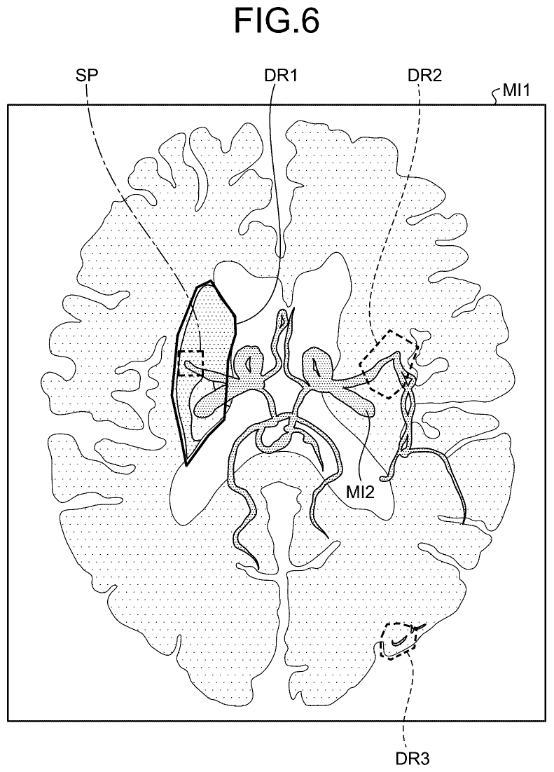

FIG. 6 is a diagram illustrating an example of the second medical image MI2 superimposed on the first medical image MI1, three disease regions DR1, DR2, and DR3 in the display mode corresponding to the binary value of the certainty, and the constriction part SP. The first medical image MI1 in FIG. 6 corresponds to the DWI image. The second medical image MI2 in FIG. 6 corresponds to the MRA image. The first disease region DR1 indicates a disease region corresponding to non-false positive (true positive). The second disease region DR2 and the third disease region DR3 indicate disease regions corresponding to false positive. As illustrated in FIG. 6, a line type of a frame line indicating the first disease region DR1 is a solid line. On the other hand, a line type of frame lines indicating the second disease region DR2 and the third disease region DR3 is a dotted line.

The processing circuitry 34 may change, by the display control function 34e, the display mode of the disease region DR in accordance with the degree of certainty (for example, the probability of the disease), and cause the display 32 to display the superimposed image. At this point, the display 32 displays the disease region DR in the display mode corresponding to the probability of the disease in the superimposed image.

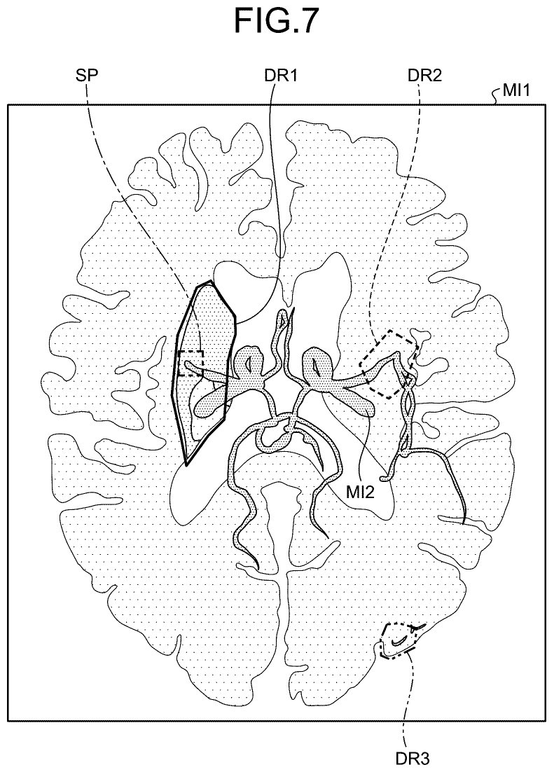

FIG. 7 is a diagram illustrating an example of the second medical image MI2 superimposed on the first medical image MI1, the three disease regions DR1, DR2, and DR3 in the display mode corresponding to the degree of certainty, and the constriction part SP. The first medical image MI1 in FIG. 7 corresponds to the DWI image. The second medical image MI2 in FIG. 7 corresponds to the MRA image. The first disease region DR1 indicates a disease region having the highest probability. The second disease region DR2 indicates a disease region having the lowest probability. The third disease region indicates a disease region having a medium probability such that the probability is lower than that of the first disease region DR1 and the probability is higher than that of the second disease region DR2, for example.

As illustrated in FIG. 7, the line type of the frame line indicating the first disease region DR1, the line type of the frame line indicating the second disease region DR2, and the line type of the frame line indicating the third disease region DR3 are different from each other. Although not illustrated in FIG. 7, the probability may be displayed in the vicinity of the three disease regions DR1, DR2, and DR3.

As an application example of the present embodiment, in a case in which the imaging part is the brain of the subject, an infarction on the left or right of the brain (unilateral infarction) or a bilateral infarction may be automatically determined based on a result of the region estimation display processing (for example, the superimposed image displayed on the display 32 at Step S405) after the processing at Step S405.

The medical image processing apparatus 30 according to the embodiment described above acquires the first medical image MI1 collected by predetermined imaging for the imaging part of the subject and the second medical image MI2 that is collected by imaging different from the predetermined imaging and includes the blood vessel related to the imaging part, detects the disease candidate region indicating the candidate for the region of the disease at the imaging part based on the first medical image MI1, detects the constriction part related to constriction of the blood vessel based on the second medical image MI2, estimates the certainty of the disease for the disease candidate region based on the disease candidate region and the constriction part, and displays the region of the disease related to the certainty and the second medical image that are superimposed on the first medical image.

In the medical image processing apparatus 30 according to the embodiment, for example, the estimated certainty in a case in which the constriction part overlaps the disease candidate region is higher than that in a case in which the constriction part does not overlap the disease candidate region. In the medical image processing apparatus 30 according to the embodiment, the constriction part is a region in which blood vessels on the downstream side of the constriction position are distributed, and the region of the disease is included in the constriction part. In the medical image processing apparatus 30 according to the embodiment, the first medical image and the second medical image are images obtained by imaging the subject at different timings, for example. In the medical image processing apparatus 30 according to the embodiment, the first medical image MI1 is, for example, a diffusion weighted image, and the second medical image MI2 is, for example, a magnetic resonance angiography image.

The medical image processing apparatus 30 according to the embodiment estimates that the disease candidate region is false positive as the certainty in a case in which the size of the overlapping region of the constriction part and the disease candidate region is smaller than the predetermined value, estimates that the disease candidate region is non-false positive as the certainty in a case in which the size of the overlapping region is equal to or larger than the predetermined value, and displays the boundary line (frame line) of the region of the disease corresponding to false positive and the boundary line (frame line) of the region of the disease corresponding to non-false positive in different display modes. The medical image processing apparatus 30 according to the embodiment detects the degree of constriction of the blood vessel at the constriction position, estimates the probability of the disease corresponding to the certainty based on the size of the overlapping region of the constriction part and the disease candidate region and the degree of constriction, and displays the boundary line (frame line) of the region of the disease in the display mode corresponding to the probability.

Accordingly, with the medical image processing apparatus 30 according to the embodiment, a point where constriction (including occlusion) of the blood vessel occurs can be specified in the second medical image acquired by imaging the same imaging part as the first medical image used for detecting the disease candidate region at the imaging part, and the disease region corresponding to the constriction part can be narrowed down from the disease candidate region while considering the dominated region of the blood vessel. For example, with the medical image processing apparatus 30 according to the embodiment, correctness of the extracted disease candidate region (certainty of the disease) can be determined (estimated) based on the occlusion (constriction) point of the blood vessel. Specifically, with the medical image processing apparatus 30 according to the embodiment, the certainty of the disease in the extracted disease candidate region can be determined based on the dominated region of the blood vessel (PCA, MCA, ACA, or left and right).

For example, with the medical image processing apparatus 30 according to the embodiment, the extracted disease candidate region can be treated to be false positive if there is no anomaly (if there is no constriction part) in the blood vessel in the extracted disease candidate region. With the medical image processing apparatus 30 according to the embodiment, if the state of the blood vessel is not occlusion but constriction, the probability of the disease in the extracted disease candidate region can be lowered as compared with that at the time of occlusion. With the medical image processing apparatus 30 according to the embodiment, a plurality of types of images (an MRA image, a CTA image, an angiography image, and the like) can be used as the second medical image used for grasping the state of the blood vessel at the imaging part. With the medical image processing apparatus 30 according to the embodiment, a non-contrast CT image may be used as the first medical image MI1 and an MRI image may be used as the second medical image MI2, or a DWI image may be used as the first medical image MI1 and a CTA image may be used as the second medical image MI2. In this way, medical images collected with different modalities can be used as a combination of the first medical image MI1 and the second medical image MI2.

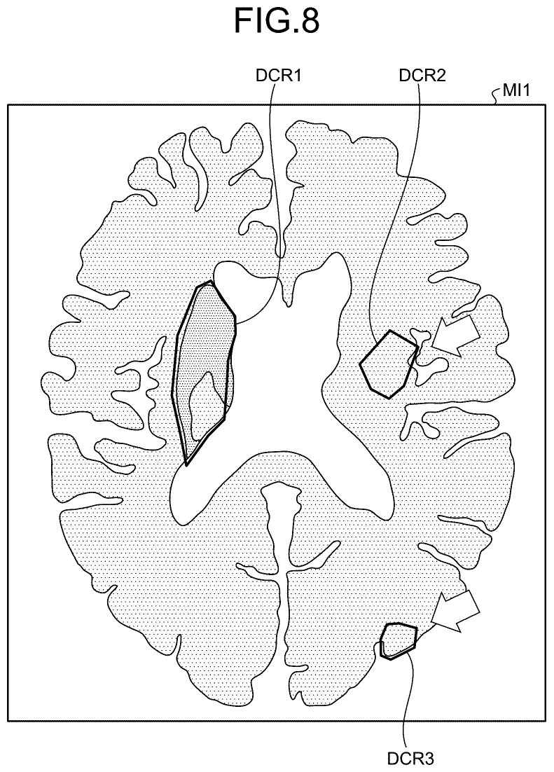

FIG. 8 is a diagram illustrating an example of a comparative example. In FIG. 8, two disease candidate regions DCR2 and DCR3 indicated by arrows are displayed in the same display mode (line type) as that of another disease candidate region DCR1. Additionally, in FIG. 8, the second medical image MI2 is not superimposed on the first medical image MI1, and is not used for estimating the certainty of the disease for the disease candidate regions DCR1, DCR2, and DCR3. In FIG. 8, a user needs to determine the certainty of the disease candidate region only from the first medical image MI1.

On the other hand, as illustrated in FIG. 5 to FIG. 7, the medical image processing apparatus 30 according to the present embodiment can display the second medical image MI2 superimposed on the first medical image MI1, the disease region DR, and the constriction part SP. As compared with FIG. 8, in FIG. 5, the disease candidate regions DCR2 and DCR3 estimated to be false positive are hidden, and the second medical image MI2 is displayed together with the constriction part SP. As compared with FIG. 8, in FIG. 6, the disease candidate regions DCR2 and DCR3 estimated to be false positive are displayed with the line type different from that of the disease candidate region DCR1 estimated to be non-false positive (true positive), and the second medical image MI2 is displayed together with the constriction part SP. As compared with FIG. 8, in FIG. 7, each of the three disease candidate regions DCR1, DCR2, and DCR3 is displayed with the line type corresponding to the probability indicating the certainty of the disease, and the second medical image MI2 is displayed together with the constriction part SP.

With the medical image processing apparatus 30 according to the embodiment, as illustrated in FIG. 5, the constriction part SP is superimposed on the first medical image MI1 together with the second medical image MI2 as a basis for estimating the certainty of the disease as compared with FIG. 8 as the comparative example, so that the user can easily grasp a positional relation between the disease region and the constriction part. With the medical image processing apparatus 30 according to the embodiment, as illustrated in FIG. 6, the user can easily grasp the certainty of the disease in a plurality of disease regions as compared with FIG. 8 as the comparative example. With the medical image processing apparatus 30 according to the embodiment, as illustrated in FIG. 7, the user can easily grasp the degree of certainty of the disease in a plurality of disease regions as compared with FIG. 8 as the comparative example.

Accordingly, with the medical image processing apparatus 30 according to the embodiment, the certainty of the disease in the disease region can be presented to the user by estimating the certainty of the disease in the region as a candidate for the disease using a region related to constriction at the imaging part. Due to this, with the medical image processing apparatus 30 according to the embodiment, qualitative determination by the user can be reduced, so that accuracy of the inspection for the subject can be improved, and throughput of the inspection can be improved.

### First Modification

In this modification, when a catheter is selected as a treatment plan for a disease, a type of the catheter used for the treatment is estimated based on a degree of constriction and a shape of a blood vessel, and the estimated type of the catheter is displayed. For example, if a catheter is selected for the treatment for the disease at the imaging part of the subject based on an instruction from a user via the input interface 31, the processing circuitry 34 estimates (specifies), by the estimation function 34d, the type of the catheter used for the treatment for the imaging part based on the degree of constriction and the shape of the blood vessel. In this case, the estimation function 34d may also be referred to as a specification unit. For example, the type of the catheter is classified based on a thickness of the catheter, a shape of a curve at a front end of the catheter, and the like.

Specifically, the estimation function 34d reads out, from the memory 33, a table of correspondence of the type of the catheter with respect to a degree of constriction (for example, a constriction rate) and the shape of the blood vessel (for example, a degree of a curve of the blood vessel) having a predetermined length including a constriction position. The predetermined length is several centimeters or several millimeters, which is set in advance. Subsequently, the second detection function 34c detects the degree of constriction and the shape of the blood vessel related to constriction based on a magnetic resonance angiography (MRA) image. A known image processing method can be applied to detection of the shape of the blood vessel, so that description thereof will not be provided. The estimation function 34d specifies the type of the catheter by comparing the detected degree of constriction and shape of the blood vessel with the table of correspondence.

The display 32 displays the estimated type of the catheter. At this point, the display 32 may further display a superimposed image in which the MRA image is superimposed on a DWI image.

The medical image processing apparatus 30 according to the first modification of the embodiment can notify the user of the type of the catheter suitable for the treatment when the catheter is selected as the treatment plan for the disease. Due to this, with the medical image processing apparatus 30 according to the first modification of the embodiment, the catheter suitable for the treatment can be easily selected by the user, and throughput related to the treatment for the subject can be improved.

### Second Modification

In this modification, the second medical image is transmitted to an X-ray blood vessel photographing apparatus (X-ray angiographic apparatus) to align the second medical image (MRA image) and a fluoroscopic image of the imaging part of the subject and superimpose the second medical image on the fluoroscopic image. Before performing X-ray fluoroscopy on the subject, the processing circuitry 34 transmits the second medical image (MRA image) to the X-ray blood vessel photographing apparatus. The processing circuitry 34 that transmits the second medical image (MRA image) to the X-ray blood vessel photographing apparatus corresponds to a transmission unit.

The X-ray blood vessel photographing apparatus generates a fluoroscopic image by fluoroscopic photographing for the subject. Subsequently, the X-ray blood vessel photographing apparatus aligns the MRA image and the fluoroscopic image. The alignment can be implemented by a known method, so that description thereof will not be provided. The X-ray blood vessel photographing apparatus superimposes the MRA image after the alignment on the fluoroscopic image with predetermined transparency, and causes it to be displayed on a display (not illustrated).

With the medical image processing apparatus 30 according to the second modification of the embodiment, the MRA image can be superimposed on the fluoroscopic image with predetermined transparency to be displayed on the display in fluoroscopic photographing for the subject. Due to this, the medical image processing apparatus 30 according to the second modification of the embodiment can improve throughput related to a treatment for the subject at the time of using a catheter, for example, in fluoroscopic photographing for the subject.

### Third Modification

In this modification, a third medical image (MRA image) including a blood vessel related to the imaging part is acquired by imaging the imaging part after the treatment for the disease of the subject, the position of the constriction part is indicated, and the third medical image (hereinafter, referred to as an MRA image after the treatment) is displayed. For example, the processing circuitry 34 acquires, by the acquisition function 34a, the third medical image (MRA image) including the blood vessel related to the imaging part from the medical image diagnostic apparatus (MRI apparatus) 10 or the image storage apparatus 20 by imaging the imaging part after the treatment for the disease of the subject. At this point, the processing circuitry 34 may cause the display control function 34e to superimpose the second medical image on the third medical image to be displayed on the display 32.

The display 32 displays the third medical image while indicating the position of the constriction part. The display 32 displays the third medical image and the second medical image in a comparable manner. For example, the display 32 superimposes the second medical image on the third medical image to be displayed. At this point, the second medical image has predetermined transparency. The display 32 may also display the third medical image and the second medical image in parallel. The display 32 may also display a difference image between the third medical image and the second medical image.

Accordingly, the medical image processing apparatus 30 according to the third modification of the embodiment can display the MRA image after the treatment on the display 32 while indicating the position of the constriction part. With the medical image processing apparatus 30 according to the third modification of the embodiment, the MRA image after the treatment and the MRA image before the treatment can be displayed in a comparable manner. Due to this, with the medical image processing apparatus 30 according to the third modification of the embodiment, the user can easily grasp an effect of the treatment for the constriction part in the MRA image after the treatment.

### Fourth Modification

In this modification, a fourth medical image is acquired by imaging the imaging part after the treatment for the disease, a degree of reduction of the region of the disease is estimated based on the first medical image and the fourth medical image, and a timing of rehabilitation of the subject is estimated and displayed based on the degree of reduction of the region of the disease. For example, the processing circuitry 34 acquires, by the acquisition function 34a, the fourth medical image by imaging the imaging part after the treatment for the disease of the subject. In a case in which the first medical image is an extended image, the fourth medical image corresponds to a diffusion weighted image of the imaging part after the treatment.

The processing circuitry 34 estimates, by the estimation function 34d, the degree of reduction of the region of the disease at the imaging part based on the first medical image and the fourth medical image. For example, the estimation function 34d calculates a ratio of the region of the disease in the fourth medical image to the region of the disease in the first medical image. If the ratio is equal to or smaller than 1, the ratio corresponds to a reduction rate of the region of the disease. That is, the degree of reduction of the region of the disease corresponds to the reduction rate.

The processing circuitry 34 estimates the timing of rehabilitation of the subject based on the degree of reduction (reduction rate) by the estimation function 34d. For example, the estimation function 34d estimates the timing of rehabilitation by comparing a threshold set in advance with the reduction rate. That is, the estimation function 34d estimates a timing of starting rehabilitation based on an effect after the treatment.

The display 32 displays the estimated timing of starting rehabilitation. At this point, the display 32 may further display the first medical image and the fourth medical image. The display 32 may also display an image in which the fourth medical image is superimposed on the first medical image. The display 32 may further display the degree of reduction of the region of the disease.

Accordingly, with the medical image processing apparatus 30 according to the fourth modification of the embodiment, the timing of starting rehabilitation can be estimated and displayed based on the medical image (for example, a diffusion weighted image) before and after the treatment. Due to this, with the medical image processing apparatus 30 according to the fourth modification of the embodiment, the user can easily grasp the timing of starting rehabilitation.

In a case of implementing a technical idea of the present embodiment by a medical image processing method, the medical image processing method includes: acquiring the first medical image collected by predetermined imaging for the imaging part of the subject and the second medical image that is collected by imaging different from the predetermined imaging and includes the blood vessel related to the imaging part; detecting the disease candidate region indicating a candidate for the region of the disease at the imaging part based on the first medical image; detecting the constriction part related to constriction of the blood vessel based on the second medical image; estimating the certainty of the disease for the disease candidate region based on the disease candidate region and the constriction part; and displaying the region of the disease related to the certainty and the second medical image that are superimposed on the first medical image. A processing procedure of the medical image processing method conforms to the procedure of region estimation display processing. An effect of the medical image processing method is the same as that of the embodiment. Due to these facts, description of the processing procedure and the effect of the region estimation display processing in the medical image processing method will not be provided.

In a case of implementing the technical idea of the embodiment with a medical image processing program, the medical image processing program causes a computer to implement: acquiring the first medical image collected by predetermined imaging for the imaging part of the subject and the second medical image that is collected by imaging different from the predetermined imaging and includes the blood vessel related to the imaging part; detecting the disease candidate region indicating a candidate for the region of the disease at the imaging part based on the first medical image; detecting the constriction part related to constriction of the blood vessel based on the second medical image; estimating the certainty of the disease for the disease candidate region based on the disease candidate region and the constriction part; and displaying the region of the disease related to the certainty and the second medical image that are superimposed on the first medical image.

For example, the region estimation display processing can also be implemented by installing image processing programs in a computer such as the medical image processing apparatus 30, the medical image diagnostic apparatus 10, and/or the image storage apparatus (PACS server) 20 illustrated in FIG. 1, and loading them into a memory. At this point, a computer program that can cause the computer to perform the processing can be stored in a storage medium such as a magnetic disc (a hard disk and the like), an optical disc (a CD-ROM, a DVD, and the like), or a semiconductor memory to be distributed. The medical image processing program is not necessarily distributed by using the medium described above, but may be distributed by using a telecommunication function such as download via the Internet, for example. The processing procedure with the medical image processing program conforms to the region estimation display processing. The effect of the medical image processing program is the same as that of the embodiment. Due to these facts, description of the processing procedure and the effect of the region estimation display processing with the medical image processing program will not be provided.

A technical feature of the present embodiment can be implemented by an MRI apparatus, for example. In this case, processing circuitry mounted on a console in the MRI apparatus includes the acquisition function 34a, the first detection function 34b, the second detection function 34c, the estimation function 34d, and the display control function 34e illustrated in FIG. 1. At this time, the MRI apparatus implements the region estimation display processing. The processing procedure with the MRI apparatus that implements the acquisition function 34a, the first detection function 34b, the second detection function 34c, the estimation function 34d, and the display control function 34e conforms to the region estimation display processing in the embodiment. The effect of the MRI apparatus is the same as that of the embodiment. Due to these facts, description of the processing procedure and the effect of the region estimation display processing with the MRI apparatus will not be provided.

According to at least the embodiment and the like described above, the certainty of the disease in the region as a candidate for the disease can be estimated by using the region related to constriction at the imaging part.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical image processing apparatus comprising:
processing circuitry configured to
acquire a first medical image collected by predetermined imaging for an imaging part of a subject and a second medical image that is collected by imaging different from the predetermined imaging and includes a blood vessel related to the imaging part,
detect a disease candidate region indicating a candidate for a region of a disease at the imaging part based on the first medical image,
detect a constriction part related to constriction of the blood vessel based on the second medical image, and
estimate certainty of the disease for the disease candidate region based on the disease candidate region and the constriction part; and
a display configured to display the region of the disease related to the certainty and the second medical image that are superimposed on the first medical image.

2. The medical image processing apparatus according to claim 1, wherein, in a case in which the constriction part overlaps the disease candidate region, the certainty is higher as compared with a case in which the constriction part does not overlap the disease candidate region.

3. The medical image processing apparatus according to claim 2, wherein,
the processing circuitry estimates that the disease candidate region is false positive as the certainty in a case in which a size of an overlapping region of the constriction part and the disease candidate region is smaller than a predetermined value,
the processing circuitry estimates that the disease candidate region is non-false positive as the certainty in a case in which the size of the overlapping region is equal to or larger than the predetermined value, and
the display displays a boundary line of the region of the disease corresponding to the false positive and a boundary line of the region of the disease corresponding to the non-false positive in different display modes.

4. The medical image processing apparatus according to claim 1, wherein
the constriction part is a region in which blood vessels on a downstream side of a position of the constriction are distributed, and
the region of the disease is included in the constriction part.

5. The medical image processing apparatus according to claim 4, wherein
the processing circuitry
detects a degree of constriction of a blood vessel at the position of the constriction, and
estimates a probability of the disease corresponding to the certainty based on the size of the overlapping region of the constriction part and the disease candidate region and the degree of constriction, and
the display displays a boundary line of the region of the disease in a display mode corresponding to the probability.

6. The medical image processing apparatus according to claim 1, wherein the first medical image and the second medical image are images obtained by imaging the subject at different timings.

7. The medical image processing apparatus according to claim 1, wherein
the first medical image is a diffusion weighted image, and
the second medical image is a magnetic resonance angiography image.

8. The medical image processing apparatus according to claim 5, wherein,
when a catheter is selected for a treatment for the disease, the processing circuitry estimates a type of the catheter based on the degree of constriction and the shape of the blood vessel, and
the display displays the estimated type of the catheter.

9. The medical image processing apparatus according to claim 1, wherein the processing circuitry transmits the second medical image to an X-ray blood vessel photographing apparatus to align the second medical image and a fluoroscopic image of an imaging part of the subject and superimpose the second medical image on the fluoroscopic image.

10. The medical image processing apparatus according to claim 5, wherein
the processing circuitry acquires a third medical image including the blood vessel related to the imaging part by imaging the imaging part after the treatment for the disease, and
the display displays the third medical image while indicating a position of the constriction part.

11. The medical image processing apparatus according to claim 10, wherein the display displays the third medical image and the second medical image in a comparable manner.

12. The medical image processing apparatus according to claim 5, wherein
the processing circuitry
acquires a fourth medical image by imaging the imaging part after the treatment for the disease,
estimates a degree of reduction of the region of the disease based on the first medical image and the fourth medical image, and
estimates a timing of rehabilitation of the subject based on the degree of reduction, and
the display displays the timing of rehabilitation.

13. A medical image processing method comprising:
acquiring a first medical image collected by predetermined imaging for an imaging part of a subject and a second medical image that is collected by imaging different from the predetermined imaging and includes a blood vessel related to the imaging part;
detecting a disease candidate region indicating a candidate for a region of a disease at the imaging part based on the first medical image;
detecting a constriction part related to constriction of the blood vessel based on the second medical image;
estimating certainty of the disease for the disease candidate region based on the disease candidate region and the constriction part; and
displaying the region of the disease related to the certainty and the second medical image that are superimposed on the first medical image.

14. A non-transitory computer readable nonvolatile storage medium storing a medical image processing program comprising programmed instructions, wherein the instructions, when executed by a computer, cause the computer to perform:
acquiring a first medical image collected by predetermined imaging for an imaging part of a subject and a second medical image that is collected by imaging different from the predetermined imaging and includes a blood vessel related to the imaging part;
detecting a disease candidate region indicating a candidate for a region of a disease at the imaging part based on the first medical image;
detecting a constriction part related to constriction of the blood vessel based on the second medical image;
estimating certainty of the disease for the disease candidate region based on the disease candidate region and the constriction part; and
displaying the region of the disease related to the certainty and the second medical image that are superimposed on the first medical image.
